(19) United States
(12) Patent Application Publication
(10) Pub. No.: US 2014/0068098 A1
(43) Pub. Date: Mar. 6, 2014

(54) REDUCING NETWORK LATENCY RESULTING FROM NON-ACCESS STRATUM (NAS) AUTHENTICATION FOR HIGH PERFORMANCE CONTENT APPLICATIONS

(71) Applicant: QUALCOMM Incorporated, San Diego, CA (US)

(72) Inventors: Kirankumar ANCHAN, San Diego, CA (US); Mark MAGGENTI, Del Mar, CA (US); Karthika PALADUGU, San Diego, CA (US); Arvind V. SANTHANAM, San Diego, CA (US)

(73) Assignee: QUALCOMM Incorporated, San Diego, CA (US)

(21) Appl. No.: 14/017,026

(22) Filed: Sep. 3, 2013

Related U.S. Application Data
(60) Provisional application No. 61/696,586, filed on Sep. 4, 2012.

(51) Int. Cl. H04L 12/801

(52) U.S. Cl. CPC H04L 47/12
USPC 709/235

(57) ABSTRACT

Aspects relating to reducing network latency in systems that use NAS Authentication/Security procedures are disclosed. For example, a method for reducing latency due to NAS authentication can include determining a number (n) or time (t) of service requests from an idle state that trigger a NAS authentication. A penultimate service request is detected before the nth service request or after time (t). A gratuitous service request is sent after the penultimate service request.

### CROSS-REFERENCE TO RELATED APPLICATIONS

The present application for patent claims the benefit of Provisional Patent Application No. 61/696,586 entitled “REDUCING NETWORK LATENCY RESULTING FROM NON-ACCESS STRATUM (NAS) AUTHENTICATION FOR HIGH PERFORMANCE CONTENT APPLICATIONS” filed Sep. 4, 2013, pending, and assigned to the assignee hereof and hereby expressly incorporated herein by reference in its entirety.

### BACKGROUND OF THE INVENTION

1. Field of the Invention

Embodiments of the invention relate to reducing network latency in systems that use NAS Authentication/Security procedure.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

### SUMMARY

In various embodiments, aspects relate to reducing network latency in systems that use NAS Authentication/Security procedures. For example, a method for reducing latency due to NAS authentication can include determining a number (n) of service requests from an idle state that trigger a NAS authentication or a time (t) from a previous service request after which a service request triggers a NAS authentication; detecting a penultimate service request before the nth service request or a penultimate time fraction before time t; and sending a gratuitous service request after the penultimate service request or the penultimate time fraction.

Various other aspects are disclosed in the following Detailed Description and in the attached drawings.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1×EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIG. 5 illustrates a call flow according to various embodiments.

FIG. 6 illustrates a flowchart according to various embodiments.

FIG. 7 illustrates a call flow according to various embodiments.

FIG. 8 illustrates a flowchart according to various embodiments.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

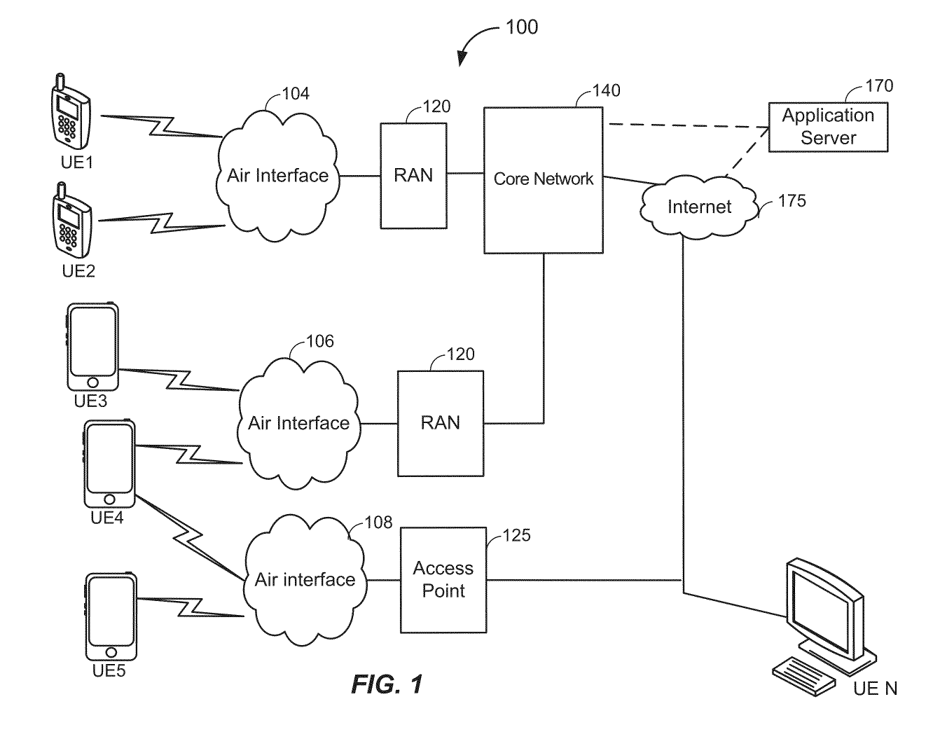

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

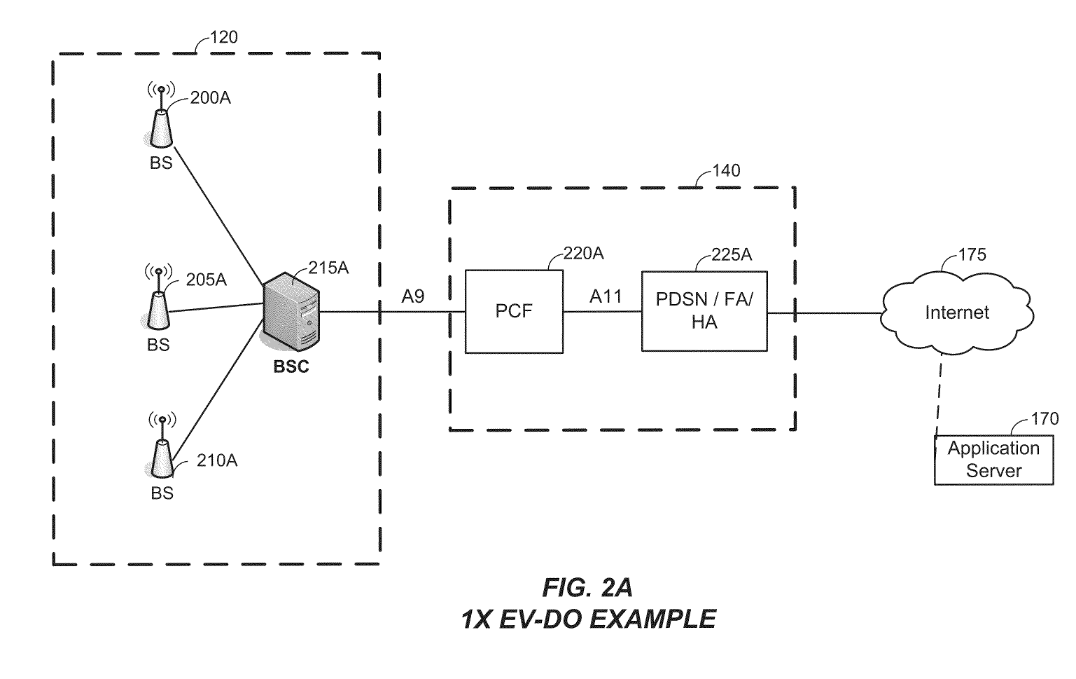

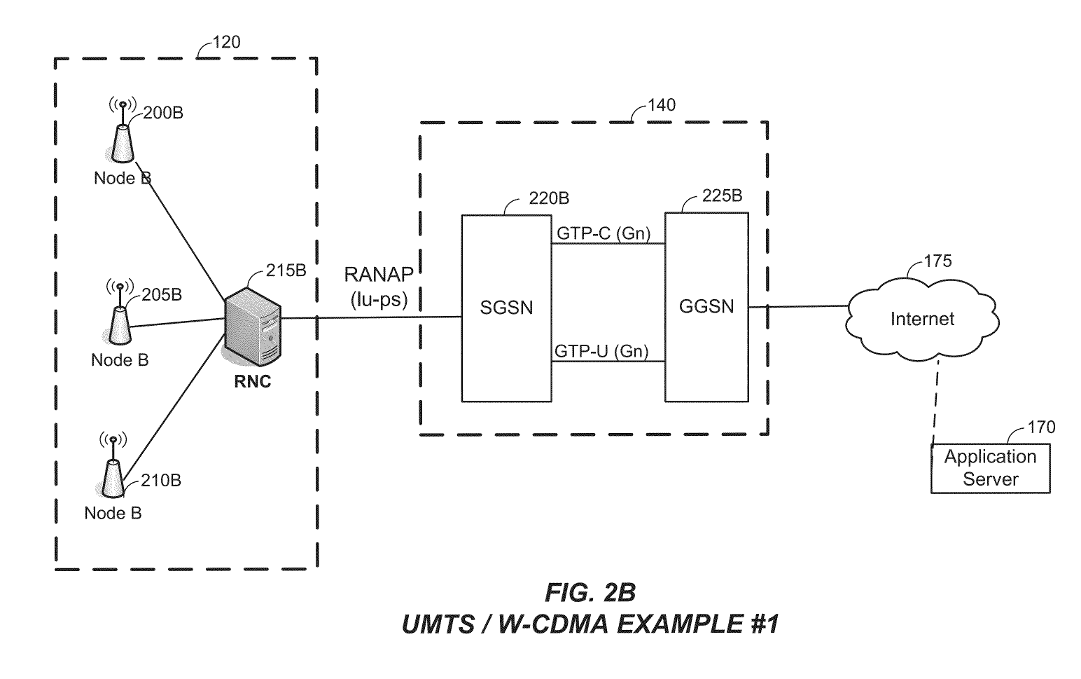

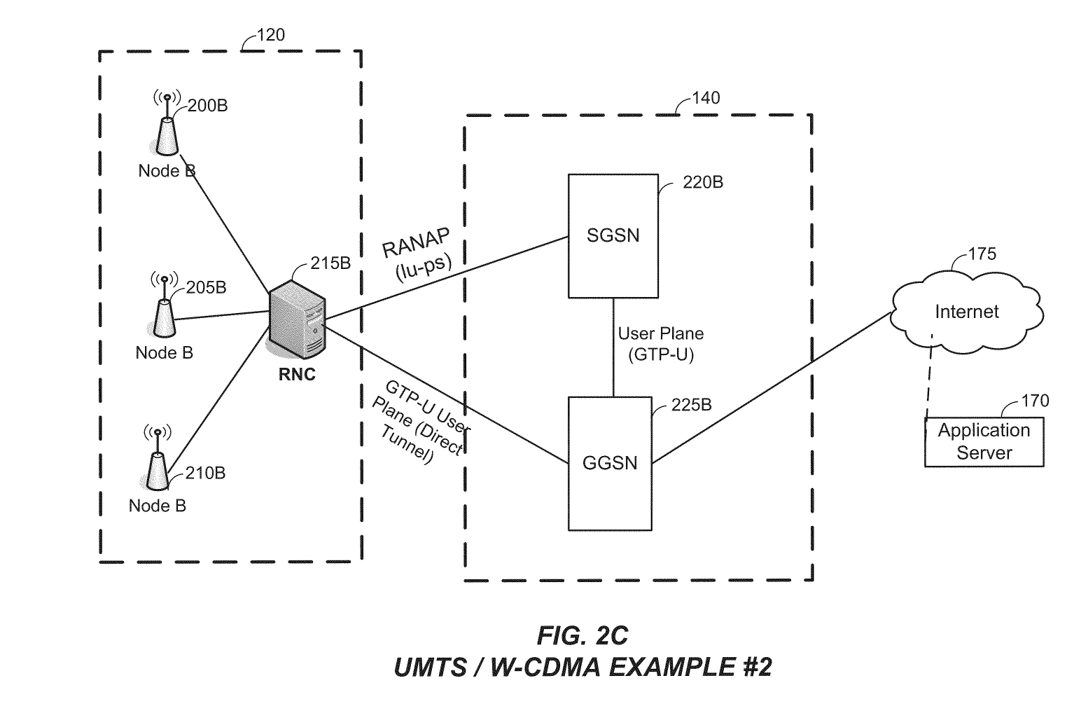

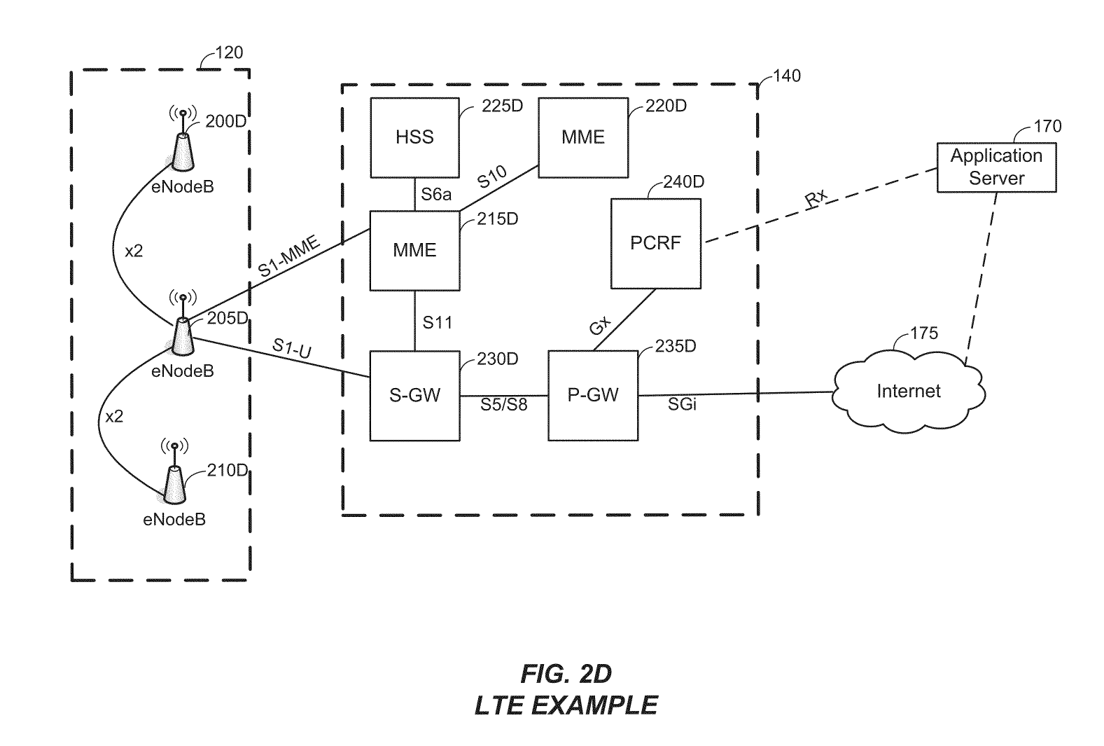

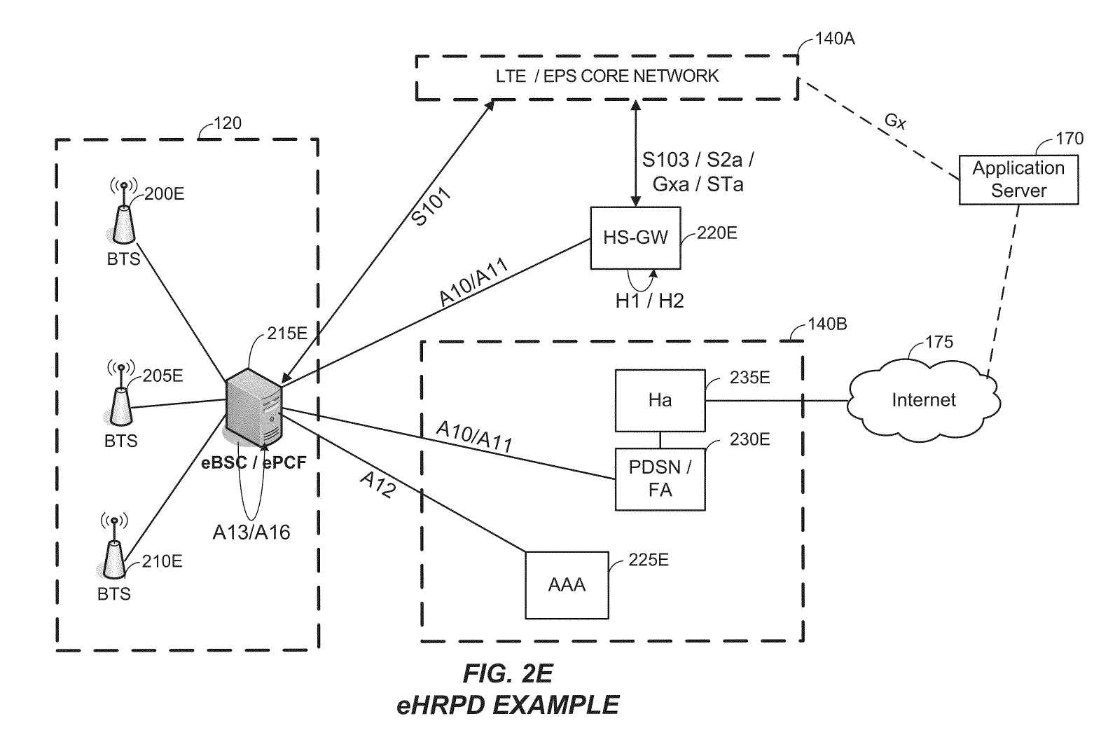

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1×EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENode Bs or eNBs) 200D, 205D and 210D, without the RNC 215B from FIGS. 2B-2C. This is because ENode Bs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMEs) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 |
| | and MME 215D. |
| S1-U | Reference point between RAN 120 and S-GW 230D for the per |
| | bearer user plane tunneling and inter-eNodeB path switching |
| | during handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement |
| | Function (PCEF) component (not shown) in the P-GW 235D. |
| S8 | Inter-PLMN reference point providing user and control plane |
| | between the S-GW 230D in a Visited Public Land Mobile |
| | Network (VPLMN) and the P-GW 235D in a Home Public Land |
| | Mobile Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for |
| | provision of IMS services). This reference point corresponds to Gi |
| | for 3GPP accesses. |
| X2 | Reference point between two different eNodeBs used for UE |
| | handoffs. |
| Rx | Reference point between the PCRF 240D and an application |
| | function (AF) that is used to exchanged application-level session |
| | information, where the AF is represented in FIG. 1 by the |
| | application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or All interfaces for interfacing with other entities in the EPS core network 140A (e.g., the S-GW 230D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

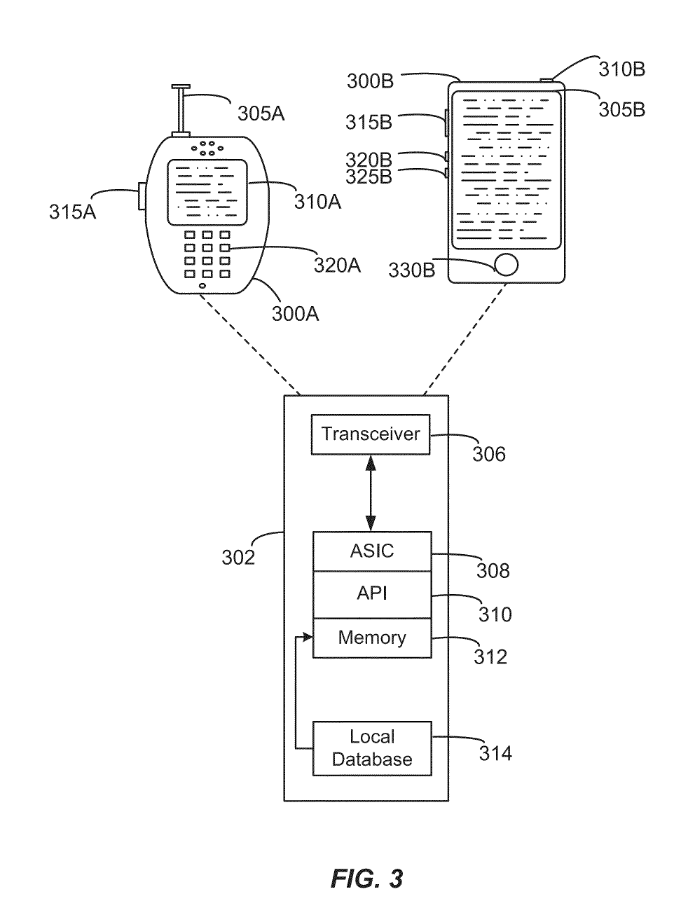

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

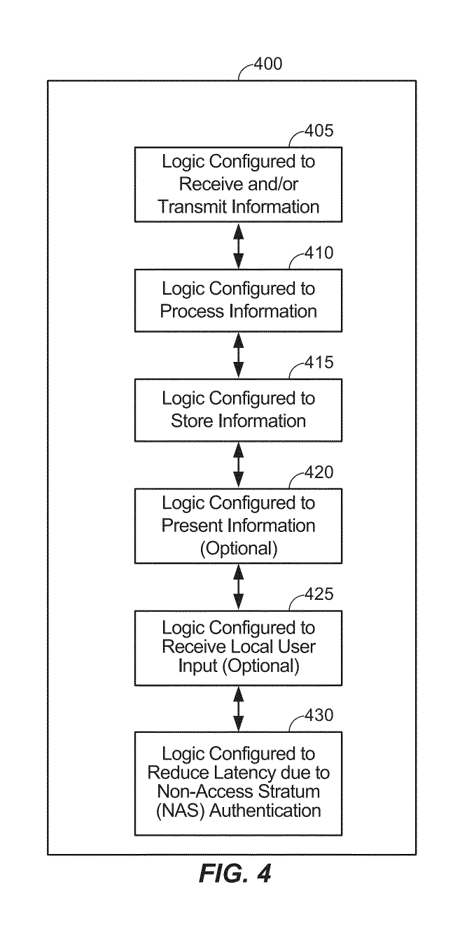

FIG. 4 illustrates a communication device 400 that includes logic configured to perform various functionalities. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A, 300B, 501, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application server 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality. Likewise, the logic configured to reduce latency due to Non-Access Stratum (NAS) authentication, 430, as discussed in detail below does not correspond to mere software code. Further, aspects will be appreciated from the following description and related drawings.

Referring to FIG. 4, while the configured logics of 405 through 430 are shown as separate or distinct blocks in FIG. 4, it will be appreciated that the hardware and/or software by which the respective configured logic performs its functionality can overlap in part. For example, any software used to facilitate the functionality of the configured logics of 405 through 430 can be stored in the non-transitory memory associated with the logic configured to store information 415, such that the configured logics of 405 through 430 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

Sessions that operate over networks such as 1×EV-DO in FIG. 2A, UMTS-based W-CDMA in FIGS. 2B-2C, LTE in FIG. 2D and eHRPD in FIG. 2E can be supported on channels (e.g. RABs, flows, etc.) for which a guaranteed quality level is reserved, which is referred to as Quality of Service (QoS). For example, establishing a given level of QoS on a particular channel may provide one or more of a minimum guaranteed bit rate (GBR) on that channel, a maximum delay, jitter, latency, bit error rate (BER), and so on. QoS resources can be reserved (or setup) for channels associated with real-time or streaming communication sessions, such as Voice-over IP (VoIP) sessions, group communication sessions (e.g., PTT sessions, etc.), online games, IP TV, and so on, to help ensure seamless end-to-end packet transfer for these sessions.

Conventionally, when a QoS bearer is setup or activated to support a UE's participation a communication session associated with a particular service (e.g., VoIP, PTT, etc.), QoS is setup for the entire duration of the communication session. When the communication session is over, the UE returns to an idle state and the QoS bearer is released.

For example, in LTE, the LTE core network maintains the S5 connection between the S-GW 230D and P-GW 235D for default EPS bearers (i.e., EPS bearers that are not allocated GBR QoS) corresponding to each PDN connection in an ‘Always On’ state, such that the non-GBR QoS EPS bearer is maintained (not released) when the UE transitions from an RRC-Connected state to an RRC-Idle state. The reason for this is that maintaining default EPS Bearer connections in active states does not impact the capacity of the LTE core network. However, for QoS bearers with GBR (“GBR QoS bearers”, or “GBR EPS bearers” if specifically in LTE), LTE core networks typically release the S5 connections when an associated UE is determined to transition from the RRC-Connected state to the RRC-Idle state to conserve resources, because maintaining the S5 connections for GBR EPS bearers consumes core network resources which limit the capacity of the LTE core network.

Certain delay-sensitive communication sessions, such as App* calls (e.g., delay-sensitive PTT calls, sensitive-VoIP calls, etc.), require the GBR QoS bearer to be brought up quickly during call setup. However, as noted above, there is no GBR QoS bearer context maintained in RRC-Idle state for LTE. As an example, Voice Over LTE (VoLTE) is based upon this assumption. Thus, the GBR QoS bearers for a delay-sensitive communication session are typically setup on demand by the application server 170 during setup of the session. One option for decreasing the call setup delays associated with GBR QoS bearer setup when a UE is transitioning from RRC-Idle state to RRC-Connected state is to maintain the S5 connection between the S-GW 230D and P-GW 235D for the GBR QoS bearer even when the UE is in RRC-Idle state. As noted above, this can significantly impact resource consumption by the LTE network.

In LTE the MME applies a NAS Authentication/Security procedure to periodic service request messages. The application of authentication check is based on the nth service request message received from the UE, where n is configurable and is conventionally set to a fixed integer number (e.g., 10, 20, . . . , 100, etc.) of requests. Some authentication schemes may set a random value for “n” during subsequent attempts. With other applications on the device requesting data and thus triggering service request, the chance of facing NAS authentication during a group communication (e.g., App* call) is relatively high. NAS authentication can add on the order of 400 ms of latency to the App* call when performed at both the ends (originator and target). It will be appreciated that this level of delay can significantly impact low latency high performance applications/commutations.

To address these increased latency issues, a UE based learning mechanism can be configured to detect the number of attempts before a NAS authentication is performed assisted. Alternatively, the number of attempts can be provided as predetermined number) to the UE from the MME. On determination of the number of attempts (e.g., by the learning mechanism, or based on network provided information, the UE monitors the number of NAS service requests. When the service request reaches the number of attempts (or a predetermined threshold), after the UE goes into RRC idle state, the UE performs a service request. The service request causes the NAS authentication. When group member devices perform background authentication, group communications will not face the NAS authentication delay due to a system enforced NAS authentication.

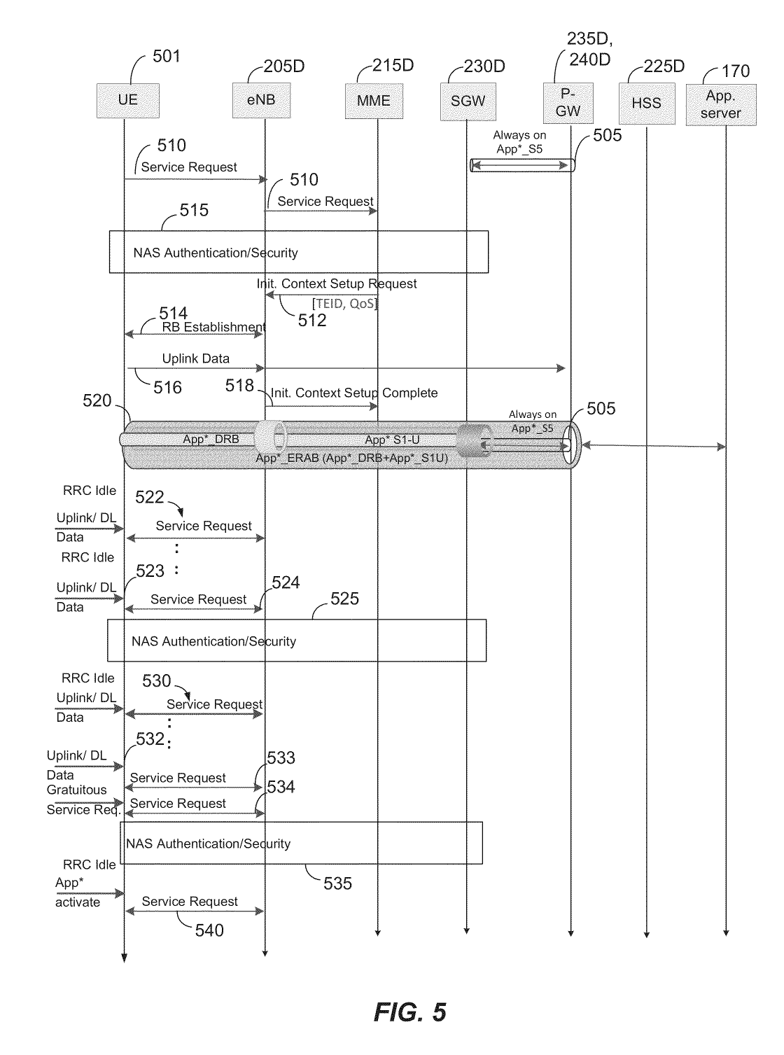

Referring to FIG. 5, the S5 connection 505 is maintained when an associated UE 501 is in RRC-Idle state. At the start of the RRC Idle-to-Connected transition, the UE 501 initiates a service request 510 and communicates the service request 510 to eNode B 205D, which in turn communicates the service request 510 to the MME 215D. As noted above, in LTE the MME 215D applies NAS authentication to periodic service request messages while retrieving user information from a database like the HSS 225D. Accordingly, after receiving the service request 510, the MME 215D performs the NAS Authentication/Security procedure 515. After the UE 501 is authenticated, the initial call setup can occur, 512, provisioning the requested services (e.g., Tunnel Endpoint ID (TEID), QoS, etc.). In 514, the bearers can be set up and the uplink data can be communicated at 516 and the initial context setup is complete in 518. After the initial setup is complete, the UE 501 (e.g., running App*) has dedicated resources for end to end communications, 520 with the application server 170.

In some embodiments, the MME 215D and eNB 205 identify the App* specific APN and or QCI to either reduce the frequency of authentication request or to only perform the authentication request on EPS bearer set-up and suppress authentication requests for other NAS signaling. After the initial NAS Authentication/Security procedure 515 are performed, subsequent service request 522 can be performed without NAS Authentication/Security procedure being performed. However, as noted above, there are a limited number of service request (e.g. n=10, 20, . . . , 100, etc.) after which when transitioning from the RRC Idle-to-Connected state, the UE 501 will have to go through another NAS authentication/security procedure. For example, in various embodiments, at 523 the UE 501 can determines the number of service requests or the time from the previous authenticated service request before the next NAS authentication/Security procedure 525 is performed, by tracking the service request (e.g., 522) and determining the number of the service request 524 that triggers the NAS authentication/Security procedure 525. Once the UE 501 has determined this number (n) or the time can use this information for subsequent communications.

For example, the UE 501 can go in and out of an RRC idle state, where upon application requests to send/receive data, service requests 530 are generated as in the foregoing. However, for subsequent NAS Authentication/Security procedure when the penultimate service request 532 is reached, the UE 501 performs a gratuitous service request 534 thus triggering the NAS authentication/Security procedure 535. For example, if n is equal to 10, then after the ninth service request, the UE 501 would generate a tenth gratuitous service request to trigger the NAS authentication/Security procedure. Similarly, for example, if t is equal to 1000 milliseconds, then at 1001 milliseconds after an authentication service request, the UE 501 would generate a gratuitous service request to trigger the NAS authentication/Security procedure. Alternatively if the UE 501 determines that the authentication requests are randomly received, it can use a threshold to determine the delivery of the gratuitous requests. This would ensure that the next real service request 540 (e.g., a call initiated by App*) could be acted upon without the possibility of excessive delay because the service request triggered the NAS Authentication/Security procedure.

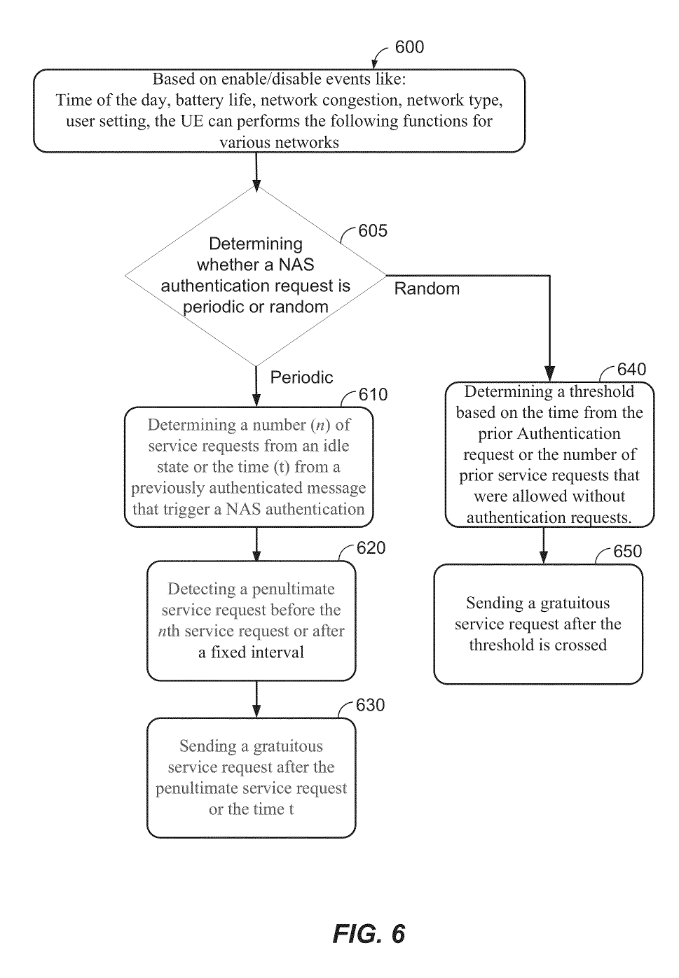

It will be appreciated that the foregoing aspects can work to reduce the latency for NAS Authentication/Security procedures. In some embodiments, NAS Authentication/Security based latency can be reduced on the order of 400 ms, such as the example embodiments of FIG. 5. To aid in further appreciation of the various embodiments, FIG. 6 illustrates a flowchart in accordance with various embodiments.

Referring to FIG. 6, a method 600 for reducing latency due to NAS Authentication/Security procedures is illustrated. The method 600 could be enabled or disabled to further optimize the UE and network impact, for example:
Based on the time of day i.e. during work hours, the App* could notify the UE to implement the method 600 to provide best latency performance and after work hours, the App* can notify the UE to disable the method 600 to provide better battery life over latency performance
More over the based on the remaining battery life threshold the UE can disable the gratuitous Service request to reduce the battery drain
Further if the RF conditions are below a certain threshold, the UE can disable the gratuitous Service request to reduce congestion resulting from repeated transmissions to improve the NAS procedure reliability
The UE can disable the method when a network type doesn't require authentication for every bearer set up, e.g., WiFi networks

In block 605, the UE determined whether the application of a NAS Authentication/Security procedure by the network is based on a periodic or a random schedule. If it is determined to be periodic, in block 610, the number (n) of service requests from an idle state that trigger a NAS Authentication/Security procedure or the time (t) after the prior NAS authentication to perform the security procedure is determined In block 620, a penultimate service request is detected (which may be immediately preceding the nth service request or at some offset from the nth service request or after a fixed interval (e.g., time (t) in milliseconds) after the previously authenticated NAS message). In 630, a gratuitous service request is sent after the penultimate service request.

It will be appreciated that various alternative and equivalent ways to perform the various method, steps, sequence of actions described in the foregoing. For example, the action of determining the number (n) can include identifying a first NAS Authentication/Security procedure; counting each service request from an idle state after the first NAS Authentication/Security procedure identifying a second NAS Authentication/Security procedure; and setting n as the count.

However, the number n may be provided from a remote device (e.g., eNodeB, MME, UTRAN, RAN, Core network components, Application server, etc.). Additionally, the gratuitous service request can be initiated immediately after entering the idle state or after a fixed interval after entering the idle state.

Referring back to FIG. 6, in block 640, after having made a determination in block 605 of a random NAS authentication, the UE can determine one or more thresholds for gratuitous service request procedures. The thresholds may be based on the time from the prior Authentication request, the number of prior service requests that were allowed without authentication requests, network congestion; network threat levels provided by a remote device (e.g., the application server). In block 650, a gratuitous service request is sent after the threshold in block 640 is reached.

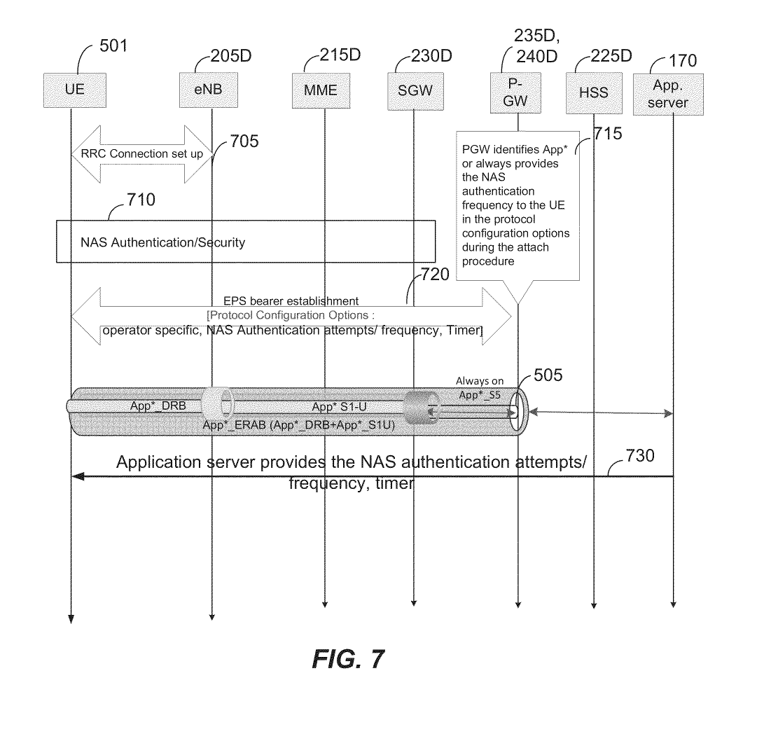

Referring to FIG. 7, a call flow according to various embodiments for reducing latency due to NAS Authentication/Security procedures is illustrated. The call flow is similar to FIG. 5 and further refines a method where a Core Network component or the application server provide the number n or the time after which the NAS message requires security procedures. Referring to 715, the P-GW based on identification of App* or based on its policy, provides the number n or the time interval after a fixed interval from the previous NAS message. The P-GW may provide this information in during the Attach produce in the Protocol Configuration Options (PCO) information element, using identifier defined for PCO for operator specific use, such as defined in 3GPP TS 24.008 section 10.5.6.3. Alternatively in 730, the application server 170 can provide the number n or the time interval after a fixed interval from the previous NAS message to the UE in separate application layer signaling.

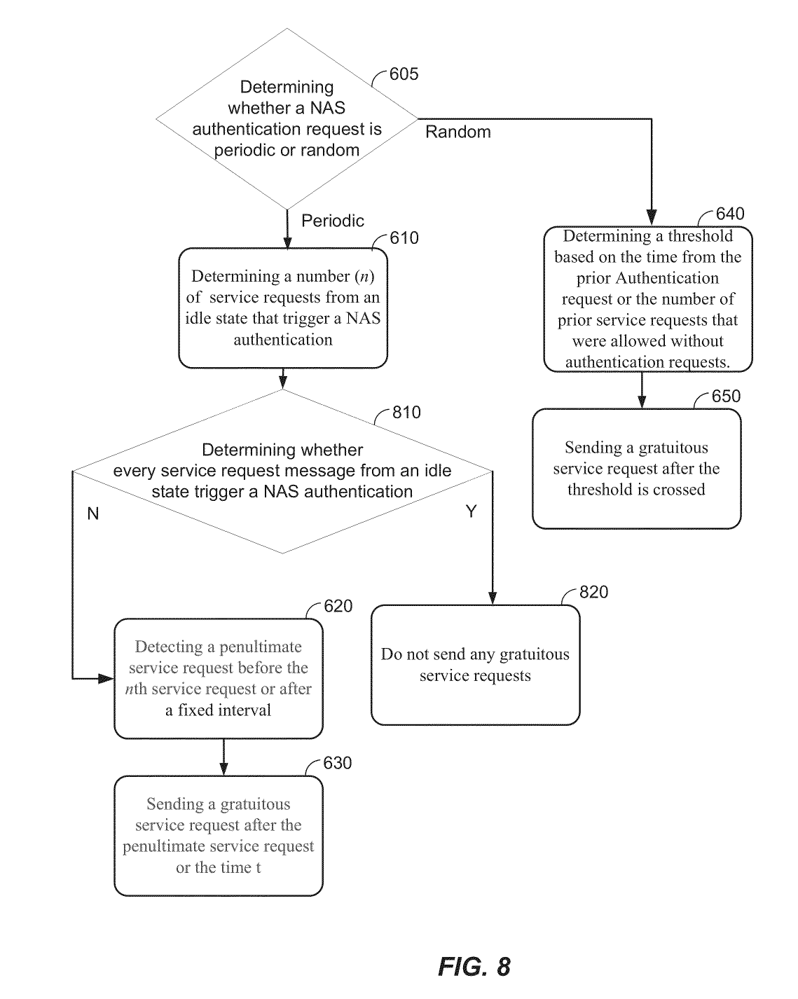

Referring to FIG. 8, a flow chart illustrating various embodiments is provided. The flow chart is further details a case when the UE determines, in block 810, whether NAS security procedures are requires for every NAS message, i.e., whether the number n is zero or greater than zero. As shown in block 820, when the UE determines that all NAS messages require security procedure, the UE disables the gratuitous service request, so the method does not send any gratuitous service requests. In this special case, there would be no latency improvement benefit as a result of the security procedure on every NAS procedure, so the gratuitous service request is procedure as discussed in the foregoing is not performed. The remaining blocks were discussed in relation to FIG. 6, so discussion will not be repeated here for brevity.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Accordingly, various embodiments can be realized as logic configured to perform the various functions and actions disclosed. For example, logic configured to reduce latency due to NAS authentication, 430, may include logic configured to determine a number (n) of service requests from an idle state that trigger a NAS authentication or the time (t) from the previous service request after which the service request trigger a NAS authentication; logic configured to detect a penultimate service request before the nth service request or the penultimate time fraction before time t; and logic configured to send a gratuitous service request after the penultimate service request of the penultimate time fraction t. Additional, functionalities can also be included in the logic configured to reduce latency due to NAS authentication, 430 or can be stand alone elements working in combination with the other various modules to perform the functionalities disclosed herein.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for reducing latency due to Non-Access Stratum (NAS) authentication comprising:
determining a number (n) of service requests from an idle state that trigger a NAS authentication or a time (t) from a previous service request after which a service request triggers the NAS authentication;
detecting a penultimate service request before the nth service request or a penultimate time fraction before time t; and
sending a gratuitous service request after the penultimate service request or the penultimate time fraction.

2. The method of claim 1, wherein n is an integer value.

3. The method of claim 2, wherein n is less than or equal to 1000.

4. The method of claim 1, wherein t is a value in milliseconds.

5. The method of claim 1, wherein determining the number (n) or time (t) comprises:
identifying a first NAS authentication;
counting each service request from the idle state after the first NAS authentication or counting the time;
identifying a second NAS authentication; and
setting n as the count or setting a timer as t.

6. The method of claim 1, wherein determining the number (n) or time (t) comprises:
receiving the number (n) or time (t) from a remote device.

7. The method of claim 1, wherein the penultimate service request is one of:
an (n−1) service request;
a service request after a predetermined number of service requests from the idle state; or
a service request after time (t).

8. The method of claim 1, wherein the gratuitous service request is initiated immediately after entering the idle state.

9. The method of claim 1, wherein the gratuitous service request is initiated a fixed interval after entering the idle state.

10. The method of claim 1, further comprising:
determining that every message is NAS authenticated; and
not sending any gratuitous service requests.

11. The method of claim 1, wherein the method is disabled based on one or more of:
a time of day setting;
a battery life threshold;
RF conditions being below a threshold; or
a network type detected.

12. The method of claim 1, wherein determining the number (n) or time (t) comprises:
evaluating a message from a server related to the number (n) or time (t).

13. The method of claim 12, wherein the message is provided in a Protocol Configuration Options (PCO) information element.

14. The method of claim 12, wherein the server is a Packet Data Network Gateway.

15. The method of claim 12, wherein the server is an application server and the message is received in separate application layer signaling.

16. An apparatus configured to reduce latency due to Non-Access Stratum (NAS) authentication comprising:
logic configured to determine a number (n) of service requests from an idle state that trigger a NAS authentication or a time (t) from a previous service request after which a service request triggers the NAS authentication;
logic configured to detect a penultimate service request before the nth service request or a penultimate time fraction before time t; and
logic configured to send a gratuitous service request after the penultimate service request or the penultimate time fraction.

17. The apparatus of claim 16, wherein n is an integer value.

18. The apparatus of claim 17, wherein n is less than or equal to 1000.

19. The apparatus of claim 16, wherein t is a value in milliseconds.

20. The apparatus of claim 16, wherein the logic configured to determine the number (n) or time (t) comprises:
logic configured to identify a first NAS authentication;
logic configured to count each service request from the idle state after the first NAS authentication or to count the time;
logic configured to identify a second NAS authentication; and
logic configured to set n as the count or to set a timer as t.

21. The apparatus of claim 16, wherein the logic configured to determine the number (n) or time (t) comprises:
logic configured to receive the number (n) or time (t) from a remote device.

22. The apparatus of claim 16, wherein the penultimate service request is one of:
an (n−1) service request;
a service request after a predetermined number of service requests from the idle state; or
a service request after time (t).

23. The apparatus of claim 16, wherein the gratuitous service request is initiated immediately after entering the idle state.

24. The apparatus of claim 16, wherein the gratuitous service request is initiated a fixed interval after entering the idle state.

25. The apparatus of claim 16, wherein the logic configured to determine, determines that every message is NAS authenticated; and the logic configured to send does not send any gratuitous service requests.

26. The apparatus of claim 16, wherein the logic to reduce latency is disabled based on one or more of:
a time of day setting;
a battery life threshold;
RF conditions being below a threshold;
a network type detected or on the logic configured to determine determining that every message is NAS authenticated.

27. The apparatus of claim 16, wherein the logic configured to determine the number (n) or time (t) comprises:
logic configured to evaluate a message from a server related to the number (n) or time (t).

28. The apparatus of claim 27, wherein the message is provided in a Protocol Configuration Options (PCO) information element.

29. The apparatus of claim 27, wherein the server is a Packet Data Network Gateway.

30. The apparatus of claim 27, wherein the server is an application server and the message is received in separate application layer signaling.

31. An apparatus for reducing latency due to Non-Access Stratum (NAS) authentication comprising:
means for determining a number (n) of service requests from an idle state that trigger a NAS authentication or a time (t) from a previous service request after which a service request triggers the NAS authentication;
means for detecting a penultimate service request before the nth service request or a penultimate time fraction before time t; and
means for sending a gratuitous service request after the penultimate service request or the penultimate time fraction.

32. The apparatus of claim 31, wherein n is an integer value.

33. The apparatus of claim 31, wherein t is a value in milliseconds.

34. The apparatus of claim 31, wherein the means for determining the number (n) or time (t) comprises:
means for identifying a first NAS authentication;
means for counting each service request from the idle state after the first NAS authentication or counting the time;
means for identifying a second NAS authentication; and
means for setting n as the count or setting a timer as t.

35. The apparatus of claim 31, wherein the penultimate service request is one of:
an (n−1) service request;
a service request after a predetermined number of service requests from the idle state; or
a service request after time (t).

36. A non-transitory computer-readable medium containing instructions stored thereon, which, when executed by one or more processors, cause an apparatus to perform operations for reducing latency due to Non-Access Stratum (NAS) authentication, the instructions comprising:
at least one instruction configured to determine a number (n) of service requests from an idle state that trigger a NAS authentication or a time (t) from a previous service request after which a service request triggers the NAS authentication;
at least one instruction configured to detect a penultimate service request before the nth service request or a penultimate time fraction before time t; and
at least one instruction configured to send a gratuitous service request after the penultimate service request or the penultimate time fraction.

37. The non-transitory computer-readable medium of claim 36, wherein n is an integer value.

38. The non-transitory computer-readable medium of claim 36, wherein t is a value in milliseconds.

39. The non-transitory computer-readable medium of claim 36, wherein the at least one instruction configured to determine the number (n) or time (t) comprises:
at least one instruction configured to identify a first NAS authentication;
at least one instruction configured to count each service request from the idle state after the first NAS authentication or to count the time;
at least one instruction configured to identify a second NAS authentication; and
at least one instruction configured to set n as the count or to set a timer as t.

40. The non-transitory computer-readable medium of claim 36, wherein the penultimate service request is one of:
an (n−1) service request;
a service request after a predetermined number of service requests from the idle state; or
a service request after time (t).
